(19) United States
(12) Patent Application Publication
(10) Pub. No.: US 2002/0062323 A1
(43) Pub. Date: May 23, 2002

(54) Browser apparatus, server apparatus, computer-readable medium, search system and search method

(75) Inventors: Sunao Takatori, Tokyo (JP); Hisanori Kiyomatsu, Chiba (JP)

Correspondence Address: Lloyd McAulay, Reed Smith LLP, 375 Park Avenue, New York, NY, 10152, US

(73) Assignee: Yozan Inc

(21) Appl. No.: 09/834,429

(22) Filed: Apr. 13, 2001

(30) Foreign Application Priority Data
Nov. 20, 2000 (JP) 2000-352189

(51) Int. Cl. G06F 7/00

(52) U.S. Cl. 707/514

(57) ABSTRACT

A browser apparatus, a server apparatus, a computer-readable medium, a search system and a search method are provided which enable a user to readily execute a search on a network particularly even if the user is a computer illiterate. In other words, for instance, the browser apparatus, the server apparatus, the computer-readable medium, the search system and the search method of the present invention perform as follows: searching sites and/or pages on the network; obtaining the values of access counters in sites and/or pages found in the search; and arranging the sites and/or the pages found in the search in accordance with the obtained access counter values so that the site or the page having the larger access counter value is ranked higher, and for outputting the information on the arrangement of the sites and/or pages as the result of the search.

### BACKGROUND OF THE INVENTION

1. Field of the Invention

The present invention relates to a browser apparatus, a server apparatus, a computer-readable medium, a search system and a search method for providing or receiving information search services, for example, over a network such as the WWW (World Wide Web).

2. Description of the Related Art

With the development of the Internet and a network such as the WWW established over the Internet, a user having information communication equipment that is connectable to the Internet can easily obtain desired information by connecting to such a network using a browser program such as Internet Explorer™ manufactured by Microsoft Corporation.

On the other hand, it is sometimes difficult to learn where desired information is located because no manager exists for managing the entire network on the Internet. Thus, on the WWW, various kinds of search engines capable of searching for one or more sites desired by a user are provided in a predetermined server by various operators, and thus search services are provided to the users.

There are mainly two kinds of searches executed by a search engine, namely, the keyword search and the category search.

With the category search, lists of categories are sequentially displayed by a browser program when a user selects once or a plurality of times any of a plurality of kinds of hierarchical categories stored in advance in the search engine along the categories, and a list of sites in which the desired information is placed is finally displayed.

In addition, with the keyword search, when a keyword is inputted in the browser program, the keyword is transmitted to a server, and the search engine of the server searches for sites relating to the keyword and transmits the result of the search to the browser program. Then, a list of links of the found sites is displayed as the result of the search by the browser program.

Further, when the browser program is started up, a top page of a portal site that is set in advance, a page designated by a user, a blank page or the like may be displayed as an initial screen.

Since, with the conventional search methods, the sites that simply match search conditions (conformance of a keyword or a selected category) are displayed on the list, a user needs to confirm reliability of information shown in the sites and completeness of the site by actually accessing the sites found in the search.

However, it is sometimes difficult for the people who are what is called computer illiterates to readily execute a search because it is complicated for them to select a category or to input a keyword using a computer.

Moreover, a user often browses one or more certain sites on the WWW repeatedly. For example, a user interested in the real estate business may browse repeatedly the site of a major real estate company, the site introducing real estate properties, a site of Yahoo® providing bulletin board services, and so on.

With the conventional browser program, although the sites frequently browsed may be registered in the bookmark by a user operation, and a desired site is browsed by selecting it from the bookmark. However, even such operations are complicated for computer illiterates.

### SUMMARY OF THE INVENTION

An object of the present invention is to provide a browser apparatus and a computer-readable medium that enable a user, particularly even a computer illiterate, to readily browse various kinds of desired information on a network with simple operations.

In addition, another object of the present invention is to provide a server apparatus, a computer-readable medium, a search system and a search method that are capable of acquiring the result of the search in which sites and/or pages are arranged in the order of the degree of reliability or completeness of information.

Moreover, another object of the present invention is to provide a browser apparatus, a computer-readable medium, a search system and a search method that are capable of acquiring the result of the search in which sites and/or pages are arranged in the order of the degree of reliability or completeness of information.

In order to attain the objects mentioned above, a browser apparatus of the present invention comprises:

access recording means for recording a history of each site or page accessed;

access counting means for counting the number of accesses to each site or page accessed in the past based on the history recorded by the access recording means; and

arranging means for arranging the links to the accessed sites and/or pages in accordance with the counted number of accesses so that the link to the site or the page accessed more is ranked higher, and for causing the display device to display the arranged links on an initial screen.

With this browser apparatus, a user, particularly even a computer illiterate, can readily browse various kinds of desired information on a network with simple operations. That is, since more frequently accessed sites are arranged and displayed higher in rank, a user can immediately recognize the frequently accessed site on the display.

In the above browser apparatus of the present invention, the arranging means causes the display device to display the number of accesses to each site or page together with the link to the site or the page.

With this browser apparatus, a user can recognize the difference among the displayed sites and/or pages by referring the numbers of accesses to the displayed sites and/or pages.

Moreover, the browser apparatus of the present invention further comprises storing means for storing information of predetermined sites and/or pages in advance, and the arranging means causes the display device to display, on the initial screen, one or more links to one or more predetermined sites and/or pages based on the information stored in the storing means as well.

With this browser apparatus, sites and/or pages that are routinely accessed can be accessed from the initial screen, and it makes operations for searching easy.

A browser apparatus of the present invention comprises:

transmitting means for transmitting a request for making a search of sites and/or pages on a network to a predetermined server;

receiving means for receiving the result of the search corresponding to the request; and

arranging means for causing a display device to display, on an initial screen, the links to sites and/or pages found in the search, based on the result of the search received by the receiving means.

With this browser apparatus, sites and/or pages found by one or more searches in the past can be accessed from the initial screen of the browser apparatus, it reduces time and efforts for executing a similar search, and makes operations for searching easy.

A computer-readable medium of the present invention has recorded therein a program that causes a computer to function as:

access recording means for recording a history of each site or page accessed;

access counting means for counting the number of accesses to each site or page accessed in the past based on the history recorded by the access recording means; and

arranging means for arranging the links to the accessed sites and/or pages in accordance with the counted number of accesses so that the link to the site or the page accessed more is ranked higher, and for causing the display device to display the arranged links on an initial screen.

The computer is caused to read and execute the program recorded in the computer-readable medium. Accordingly, a user, particularly even a computer illiterate, can browse various kinds of information provided on a network with easy operations.

Moreover, in the computer-readable medium of the present invention, according to the recorded program, the arranging means causes the display device to display the number of accesses to each site or page together with the link to the site or the page.

The computer is caused to read and execute the program recorded in the computer-readable medium. Accordingly, a user can confirm the difference among the displayed sites and/or pages by referring the numbers of accesses.

Moreover, in the computer-readable medium of the present invention, according to the recorded program, the arranging means causes the display device to display, on the initial screen, the links to predetermined sites and/or pages registered in advance as well.

The computer is caused to read and execute the program recorded in the computer-readable medium. Accordingly, sites and/or pages that are routinely accessed can be accessed from the initial screen, and it makes operations for searching easy.

A computer-readable medium of the present invention has recorded therein a program that causes a computer to function as:

transmitting means for transmitting a request for making a search of sites and/or pages on a network to a predetermined server;

receiving means for receiving the result of the search corresponding to the request; and arranging means for causing a display device to display, on an initial screen, the links to sites or pages found in the search based on the result of the search received by the receiving means.

The computer is caused to read and execute the program recorded in the computer-readable medium. Accordingly, sites and/or pages found in one or more searches in the past can be accessed from the initial screen of the browser apparatus, it reduces time and efforts for executing a similar search, and makes operations for a search easy.

A server apparatus of the present invention comprises:

searching means for searching sites and/or pages on a network;

access counter value obtaining means for obtaining the values of access counters in sites and/or pages found by the searching means; and

arranging means for arranging the sites and/or the pages found by the searching means in accordance with the access counter values obtained by the access counter value obtaining means so that the site or the page having the larger access counter value is ranked higher, and for outputting the information on the arrangement of the sites and/or pages as the result of the search.

With this server apparatus, the result of a search can be obtained in which the sites and/or the pages are arranged in the order of the degree of reliability or completeness of information, that is based on the fact that sites and/or pages with higher reliability or completeness of information are accessed more.

A search method of the present invention comprises the steps of:

searching sites and/or pages on a network;

obtaining the values of access counters in sites and/or pages found by the search; and

arranging the sites and/or the pages found in the search in accordance with the obtained access counter values so that the site or the page having the larger access counter value is ranked higher, and outputting the information on the arrangement of the sites and/or pages as the result of the search.

With this search method, the result of a search can be obtained in which the sites and/or the pages are arranged in the order of the degree of reliability or completeness of information, that is based on the fact that sites or pages with high reliability or completeness of information are accessed more.

A computer-readable medium of the present invention has recorded therein a program that causes a computer to function as:

searching means for searching sites and/or pages on a network;

access counter value obtaining means for obtaining the values of access counters in sites and/or pages found by the searching means; and

arranging means for arranging the sites and/or the pages found by the searching means in accordance with the access counter values obtained by the access counter value obtaining means so that the site or the page having the larger access counter value is ranked higher, and for outputting the information on the arrangement of the sites and/or pages as the result of the search.

The computer is caused to read and execute the program recorded in this computer-readable medium. Accordingly, the result of a search can be obtained in which the sites and/or the pages are arranged in the order of the degree of reliability or completeness of information, that is based on the fact that sites and/or pages with higher reliability or completeness of information are accessed more.

A search system of the present invention comprises a browser apparatus for requesting a search and a server apparatus, the server apparatus including:

searching means for searching sites and/or pages on a network in response to the request of the search;

access counter value obtaining means for obtaining the values of access counters in sites and/or pages found by the searching means; and

arranging means for arranging the sites and/or the pages found by the searching means in accordance with the access counter values obtained by the access counter value obtaining means so that the site or the page having the larger access counter value is ranked higher, and for transmitting the information on the arrangement of the sites or pages as the result of the search to the browser apparatus.

With this search system, the result of a search can be obtained in which the sites and/or the pages are arranged in the order of the degree of reliability or completeness of information, that is based on the fact that sites and/or pages with higher reliability or completeness of information are accessed more.

Moreover, in the search system of the present invention, the links to the sites and/or the pages found in the search are displayed on the initial screen of the display device of the browser apparatus, based on the result of the search transmitted from the server apparatus.

With this search system, a user can access a site or a page having information that attracts the interests of the general public in the world and that is excellent in reliability or completeness from the initial screen of the browser apparatus, and it makes accesses to the information on a network efficient.

A server apparatus of the present invention comprises:

receiving means for receiving a request for making a search;

searching means for searching sites and/or pages on a network in response to the request;

accumulated number recording means for accumulating and recording, if the requester of the search accesses a site or a page obtained as the result of the search by the searching means, the number of accesses to the site or the page; and

arranging means for arranging sites and/or pages found by the searching means in accordance with the number of accesses accumulated by the accumulated number recording means so that the site or the page having larger accumulated number of accesses is ranked higher, and for outputting the information on the arrangement of the sites or pages as the result of the search.

With this server apparatus, the result of a search can be obtained in which the sites and/or the pages are arranged in the order of the degree of reliability or completeness of information and in the order of the degree of interest of the user, that is based on the fact that the sites and/or pages with higher reliability or completeness of information are accessed more.

A search method of the present invention comprises the steps of:

receiving a request for making a search;

searching sites and/or pages on a network in response to the request;

accumulating, if the requester of the search accesses a site or a page obtained as the result of the search, the number of accesses to the site or the page; and

arranging sites and/or pages found in the search in accordance with the accumulated number of accesses so that the site or the page having the larger accumulated number of accesses is ranked higher, to thereby output the information on the arrangement of the sites and/or pages as the result of the search.

With this search method, the result of a search can be obtained in which the sites and/or the pages are arranged in the order of the degree of reliability or completeness of information and the degree of interest of the user, that is based on the fact that sites and/or pages with higher reliability or completeness of information are accessed more.

A computer-readable medium of the present invention has recorded therein a program that causes a computer to function as:

receiving means for receiving a request for making a search;

searching means for searching sites and/or pages on a network in response to the request;

accumulated number recording means for accumulating and recording, if the requester of the search accesses a site or a page obtained as the result of the search by the searching means, the number of accesses to the site or the page; and

arranging means for arranging sites and/or pages found by the searching means in accordance with the numbers of accesses accumulated by the accumulated number recording means so that the site or the page having the larger accumulated number of accesses is ranked higher, and for outputting the information on the arrangement of the sites and/or pages as the result of the search.

The computer is caused to read and execute the program recorded in this computer-readable medium. Accordingly, the result of a search can be obtained in which the sites and/or the pages are arranged in the order of the degree of reliability or completeness of information and the degree of interest of the user, that is based on the fact that sites and/or pages with higher reliability or completeness of information are accessed more.

A search system of the present invention comprises a browser apparatus, for requesting a search and for accessing a site or a page on a network, and a server apparatus, the server apparatus including:

receiving means for receiving the request for making a search;

searching means for searching sites and/or pages on a network in response to the request;

accumulated number recording means for accumulating and recording, if the browser apparatus accesses a site or a page obtained as the result of the search by the searching means, the number of accesses to the site or the page; and

arranging means for arranging sites and/or pages found by the searching means in accordance with the accumulated number of accesses accumulated by the accumulated number recording means so that the site or the page having the larger accumulated number of accesses is ranked higher, and for outputting the information on the arrangement of the sites and/or pages as the result of the search.

With this search system, the result of a search can be obtained in which the sites and/or the pages are arranged in the order of the degree of reliability or completeness of information and the degree of interest of the user, that is based on the fact that sites and/or pages with higher reliability or completeness of information are accessed more.

Moreover, in the search system of the present invention, the links to the sites and/or the pages found in the search are displayed on the initial screen of the display device of the browser apparatus, based on the result of the search transmitted from the server apparatus.

With this search system, a user can access sites or pages having information that attracts the interests of the general public in the world and that is excellent in reliability or completeness from the initial screen of the browser apparatus, and it makes accesses to the information efficient.

A browser apparatus of the present invention comprises:

access recording means for recording a history of each site or page accessed;

transmitting means for transmitting a request for making a search to a predetermined server;

receiving means for receiving information on sites and/or pages from the server as the result of the search;

aggregating means for aggregating the number of accesses to each site or page received by the receiving means based on the history recorded by the access recording means; and

arranging means for arranging the links to the sites and/dr pages received by the receiving means based on the history recorded by the access recording means, so that the link to the site or the page accessed more is ranked higher, and for causing the display device to display the arranged links.

With this browser apparatus, the result of a search can be obtained in which the sites and/or the pages are arranged in the order of the degree of reliability or completeness of information that is based on the fact that sites and/or pages with higher reliability or completeness of information are accessed more.

Moreover, in the browser apparatus of the present invention, the links to sites and/or pages arranged in the order of frequency of accesses to the sites and/or the pages are displayed on an initial screen of the display device of the browser apparatus.

With this browser apparatus, a user can access a site or a page having information that attracts the interests of the general public in the world and that is excellent in reliability or completeness from the initial screen of the browser apparatus, and it makes accesses to the information on a network efficient.

A search method of the present invention comprises the steps of:

recording a history of each site or page accessed;

transmitting a request for making a search to a predetermined server;

receiving information on sites and/or pages from the server as the result of the search;

aggregating the number of accesses to each site or page received from the server based on the recorded history; and

arranging the links to the sites and/or pages received by the receiving means based on the recorded history, so that the link to the site or the page accessed more is ranked higher, to thereby cause a display device of a browser apparatus to display the arranged links.

With this search method, the result of a search can be obtained in which the sites and/or the pages are arranged in the order of the degree of reliability or completeness of information, that is based on the fact that sites and/or pages with higher reliability or completeness of information are accessed more.

Moreover, in the search method of the present invention, the links to sites and/or pages arranged in the order of frequency of accesses to the sites and/or pages are displayed on an initial screen of the display device of the browser apparatus.

With this search method, a user can access a site or a page having information that attracts the interests of the general public in the world and that is excellent in reliability or completeness from the initial screen of the browser apparatus, and it makes access to the information on a network efficient.

A computer-readable medium of the present invention has recorded therein a program that causes a computer to function as:

access recording means for recording a history of each site or page accessed;

aggregating means for aggregating the number of accesses to each site or page received from a predetermined server based on the history recorded by the access recording means; and

arranging means for arranging the links to sites and/or pages received from the server based on the history recorded by the access recording means, so that the link to the site or the page accessed more is ranked higher, and for causing the display device to display the arranged links.

The computer is caused to read and execute the program recorded in the computer-readable medium. Accordingly, the result of a search can be obtained in which the sites and/or the pages are arranged in the order of the degree of reliability or completeness of information, that is based on the fact that sites and/or pages with higher reliability or completeness of information are accessed more.

Moreover, in the computer-readable medium of the present invention, according to the program, the links to sites and/or pages arranged in the order of frequency of accesses to the sites and/or the pages are displayed on the initial screen of the display device of the browser apparatus.

The computer is caused to read and execute the program recorded in the computer-readable medium. Accordingly, a user can access a site or a page having information that attracts the interests of the general public in the world and that is excellent in reliability or completeness from the initial screen of the browser apparatus, and it makes accesses to the information on a network efficient.

A search system of the present invention comprises:

a server apparatus for receiving a request for making a search, searching sites and/or pages on a network in response to the request, and outputting the result of the search; and

a browser apparatus, the browser apparatus including:

access recording means for recording a history of each site or page accessed;

transmitting means for transmitting a request for making a search to the server apparatus;

receiving means for receiving information of sites and/or pages as the result of the search from the server apparatus;

aggregating means for aggregating the number of accesses to each site or page received by the receiving means based on the history recorded by the access recording means; and

arranging means for arranging the links to the sites and/or the pages received by the receiving means based on the history recorded by the access recording means, so that the link to the site or the page accessed more is ranked higher, and for causing a display device to display the arranged links.

With this search system, the result of a search can be obtained in which the sites and/or the pages are arranged in the order of the degree of reliability or completeness of information, that is based on the fact that sites and/or pages with higher reliability or completeness of information are accessed more.

Moreover, in the above search system of the present invention, the links to sites and/or pages arranged in the order of frequency of accesses to the sites and/or the pages are displayed on an initial screen of the display device of the browser apparatus.

With this search system, a user can access a site or a page having information that attracts the interests of the general public in the world and that is excellent in reliability or completeness from the initial screen of the browser apparatus, and it makes accesses to the information on a network efficient.

### BRIEF DESCRIPTION OF THE DRAWINGS

In the accompanying drawings:

FIG. 1 is a block diagram illustrating a configuration of a search system in accordance with an embodiment of the present invention;

FIG. 2 is a block diagram illustrating a configuration of a browser apparatus in accordance with an embodiment of the present invention;

FIG. 3 is a block diagram illustrating a configuration of a server apparatus in accordance with an embodiment of the present invention; and

FIG. 4 shows an example of an initial screen to be displayed upon starting up a browser program.

### DETAILED DESCRIPTION OF THE PREFERRED EMBODIMENTS

Embodiments of the present invention will be hereinafter described based on the accompanying drawings.

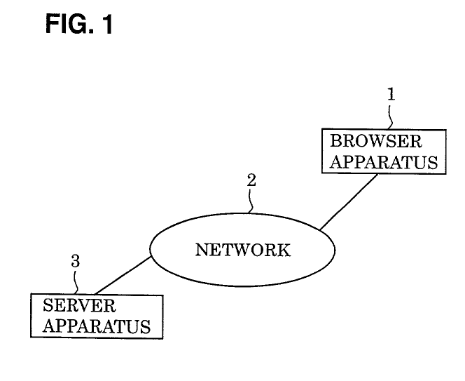

FIG. 1 is a block diagram illustrating a configuration of a search system in accordance with an embodiment of the present invention. In FIG. 1, a browser apparatus 1 and a server apparatus 3 are connected via a network 2. Here, the browser apparatus 1 is realized as a personal computer in which programs are installed, for example, a browser program or the like for processing to be described later. The network 2 is a network such as the Internet and the WWW established over the Internet to which sites are connected for providing various kinds of information. The server apparatus 3 is realized as a computer in which programs are installed, for example, a WWW server program and a search engine for processing to be described later.

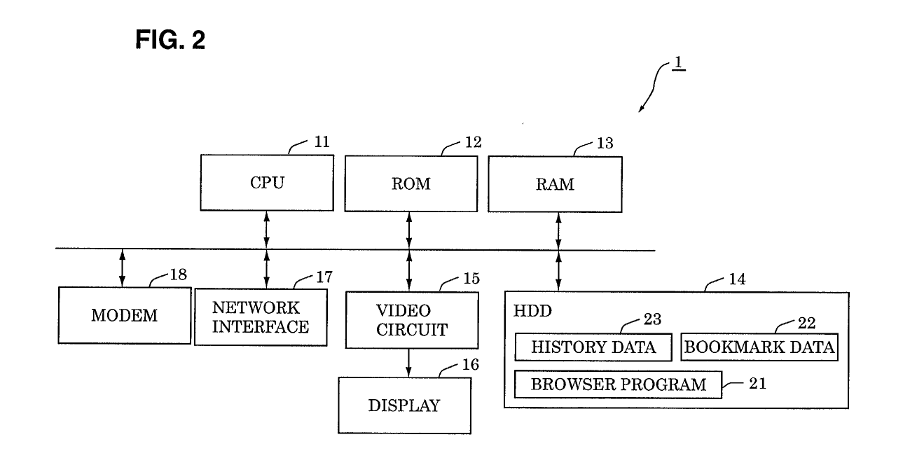

FIG. 2 is a block diagram illustrating a configuration of a browser apparatus in accordance with an embodiment of the present invention. In FIG. 2, a CPU 11 executes programs recorded in an ROM 12 and a hard disk device 14. The ROM 12 records programs for starting up an apparatus, or the like. The RAM 13 temporarily stores programs and/or data when the CPU 11 executes the programs.

In addition, the hard disk device (hereinafter referred to the HDD) 14 is a storage medium (storing means) for storing an operating system (not shown), a browser program 21 to be used for browsing www sites, bookmark data 22 having address information of one or more sites registered in advance (for example, the domain name of the site or the URL (Uniform Resource Locator) of the top page of the site), history data 23 having information of one or more sites accessed in the past (for example, the domain name of the site or the URL of the top page of the site), and the like. Further, as a computer-readable medium being recorded these programs, other computer-readable media based on the optical recording system, the magnetic recording system, the magnetooptical recording system, or the like may be used instead of the HDD 14.

Further, in this embodiment, access recording means, access counting means, arranging means, transmitting means, receiving means and aggregating means are realized by the CPU 11 reading and executing programs such as the operating system and the browser program 21 from the HDD 14 being a computer-readable medium.

Moreover, a video circuit 15 converts image data to image signals, and supplies the image signals to a display 16 to display an image. The display 16 displays an image corresponding to the supplied image signals.

Furthermore, a network interface 17 is connected to the network 2 via an LAN (Local Area Network). A modem 18 is connected to an access point such as a communication carrier or a provider via telephone lines, and is connected to the network 2 through the access point.

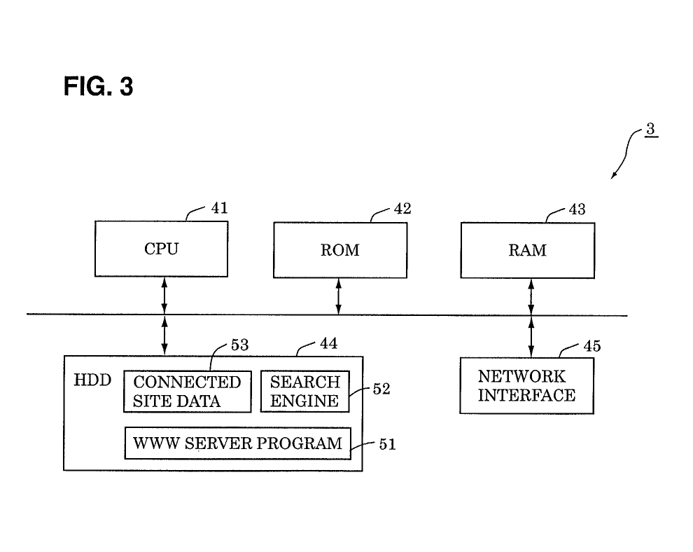

FIG. 3 is a block diagram illustrating a configuration of the server apparatus 3 in accordance with an embodiment of the present invention. In FIG. 3, a CPU 41 executes programs recorded in an ROM 42 and an HDD 44. The ROM 42 records programs for starting up an apparatus, or the like. The RAM 43 temporarily stores programs and/or data when the CPU 41 executes the programs.

In addition, the HDD 44 is a storage medium (storing means) for storing an operating system (not shown), a WWW server program 51, a search engine 52 as a program, and connected site data 53 having information of one or more sites that are selected out of sites found by the search engine 52 and then are accessed by the browser apparatus 1, and the like. Further, as a computer-readable medium being recorded these programs, other recording media based on the optical recording system, the magnetic recording system, the magnetooptical recording system, or the like may be used instead of the HDD 44.

Further, in this embodiment, searching means, access counter value obtaining means, arranging means, receiving means and accumulated number recording means are realized by the CPU 41 reading and executing programs such as the WWW server program 51 and the search engine 52 from the HDD 44 which is a computer-readable medium.

Moreover, the network interface 45 connects the server apparatus 3 to the network 2.

In the system described above, the browser apparatus 1 and the server apparatus 3 operate as follows;

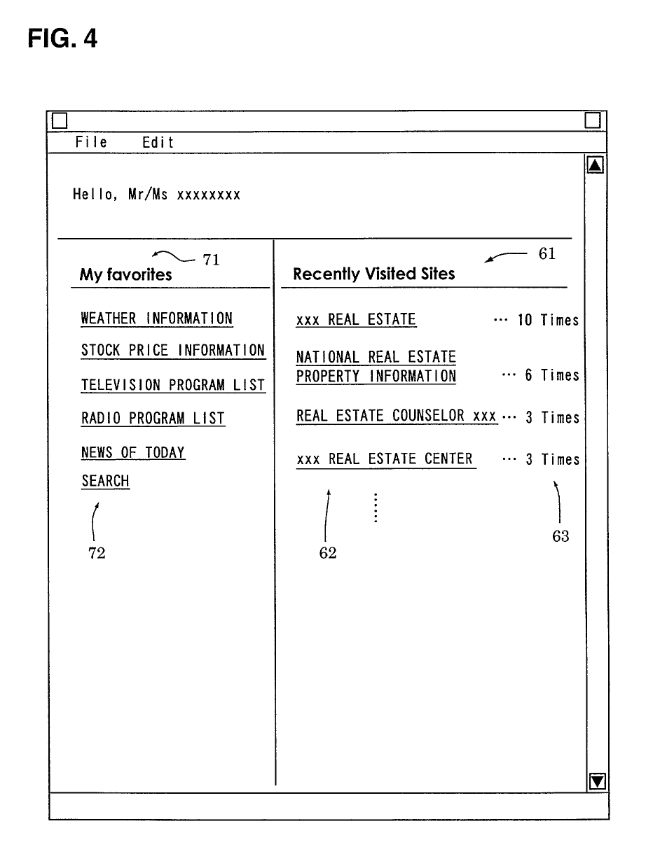

Operation of the browser apparatus 1 upon starting up the browser program 21 will be described here. FIG. 4 shows an example of an initial screen to be displayed upon starting up the browser program 21.

The browser program 21 stored in the HDD 14 is started up by the CPU 11 according to user operations or is automatically started up when the browser apparatus 1 is started up.

In accordance with the browser program 21, the CPU 11 refers to the history data 23 of the HDD 14 and counts the number of accesses for each site accessed in the past. Then, the programmed CPU 11 arranges the links to sites existing in the history data 23 in accordance with the number of accesses, so that the link to the more accessed site is ranked higher. For instance, in the case that the initial screen is displayed in HTML (Hypertext Markup Language) format, the programmed CPU 11 controls the video circuit 15, and causes the display 16 to display the arrangement of the hyperlinks to webpages on the sites.

That is, as shown in FIG. 4, for example, the programmed CPU 11 arranges the links 62 to the sites so as to give the higher rank to the the more frequently accessed site, and has the arranged links displayed under the title 61 named “Recently Visited Sites”.

Moreover, the programmed CPU 11 has the number of accesses 63 of each site displayed along with the link to each site. For example, as shown in FIG. 4, the number of accesses to the site named “xxx real estate” is displayed as “10 times”.

In addition, the programmed CPU 11 reads the bookmark data 22 being registration data in which predetermined sites are registered in advance, and has the links to the sites registered in the bookmark data 22 displayed. Further, for example, the URLs of sites that are routinely browsed are registered in the bookmark data 22 in advance.

For example, as shown in FIG. 4, the programmed CPU 11 makes display 16 display the links 72 to sites registered in the bookmark data 22 under the title 71 named “My favorites”.

Then, if a site is accessed, the programmed CPU 11 updates the history data 23 to record the fact that the site is accessed.

Further, when updating the history data 23, the programmed CPU 11 may arrange the sites currently recorded and already recorded in accordance with the number of accesses so as to give the higher rank to the more accessed site, and may record the information of the rearranged sites in the history data 23 again. After that, in the initial screen, the links of the sites may be displayed in the order as they are recorded in the history data 23. In this case, it can reduce time required for displaying the initial screen including ranking data of sites and/or pages.

In addition, although the programmed CPU 11 of the browser apparatus 1 counts the number of accesses for each site accessed in the past in accordance with the browser program 21 in this embodiment, the number of accesses may be counted using one or more plug-in programs or the like for the browser program 21.

In this way, the browser apparatus 1 arranges the links to the sites accessed in the past in accordance with the number of accesses so that the link to the more accessed site is ranked higher, and displays the arranged links on the initial screen of the display 16. Further, for example, sites stored in a cache memory may be displayed rather than those in the HDD 14 of the browser apparatus 1, or only sites accessed in a predetermined period in the sites recorded in the history data 23 of the HDD 14 may be displayed. This predetermined period may be arbitrarily changed by a user, other than a predetermined initial value (for example, one month). For example, the indication “within recent 1 month” is displayed adjacent to the title 61, in which the number “1” is displayed as the value in an input column, that is, now the predetermined period is one month, and if the user changes the value in the input column, the new value is set as the predetermined period.

In this way, various kinds of information can be easily browsed on a network by a user, particularly even by a computer illiterate, with simple operations. That is, since a frequently accessed site is arranged high in rank and the link 62 of the site is displayed in the rank, a user can immediately recognize the site the user frequently accesses that are arranged high in rank on the display.

In addition, the number of accesses to each site or page is displayed on the initial screen by the browser apparatus 1 along with the link to the site or the page accessed in the past.

In this way, the user can confirm the difference of the number of accesses among the displayed sites.

Moreover, the links to the sites registered in advance are displayed on the initial screen by the browser apparatus 1, other than the links to sites arranged in accordance with the number of accesses.

In this way, by registering in advance sites that are routinely accessed, the routinely accessed sites can be accessed from the initial screen, that makes operations for accesses to the sites easy.

Further, although the number of accesses is counted for each site in this embodiment, the number of accesses may be counted more finely for each page on the site and display the link to the page.

Next, operation of the server apparatus 3 at the time when the browser apparatus 1 requests the server apparatus 3 for a search will now be described.

The server apparatus 3 starts up the WWW server program 51 when it starts providing search services. Then, the server apparatus 3 receives, by the network interface 45, various kinds of requests transmitted from the browser apparatus 1 via the network 2, and executes processing corresponding to the requests in accordance with the WWW server program 51.

When the browser apparatus 1 connects to a site provided by the server apparatus 3, the server apparatus 3 transmits an HTML document of the webpage for the search service to the browser apparatus 1 in the HTTP (Hypertext Transfer Protocol) via the network 2 in accordance with the WWW server program 51. The browser apparatus 1 receives and displays the HTML document. This HTML document has, for example, an input column for inputting a search keyword or a list of categories.

When a request for making a search is transmitted from the browser apparatus 1 to the server apparatus 3, the programmed CPU 41 of the server apparatus 3 starts up the search engine 52, and searches sites on a network in response to the request.

Then, the CPU 41 obtains the value of an access counter set in each site found by the search engine 52, arranges the sites found in the search in accordance with the values of the access counters so that the site having the larger access counter value is ranked higher, and transmits information on the arrangement of the sites as the result of the search to the browser apparatus 1 via the network 2.

For example, if SITE A in which the value of the access counter is 10, SITE B in which the value of the access counter is 16, and SITE C in which the value of the access counter is 12 are found in the search, then URLs of those sites are transmitted in the order of SITE B, SITE C and SITE A as the result of the search.

When receiving the information on the arrangement of the sites, the browser apparatus 1 causes the display 16 to display the links to the sites in the order of the arrangement in accordance with the browser program.

In this way, the server apparatus 3 obtains the value of the access counter of each site found in the search if the access counter is set in the site, arranges the sites found in the search in accordance with the values of the access counters so that the site having the larger access counter value is ranked higher, and notifies the information of the arrangement to the browser apparatus 1.

Thus, on the assumption that sites and/or pages with higher reliability or completeness of information are accessed more, the result of the search can be obtained in which the sites are arranged in the order of the degree of reliability or completeness of information by making use of the value of the access counter.

In addition, the result of the search in which the sites are arranged so as to give the higher rank to the site having the larger access counter value, is transmitted from the server apparatus 3 to the browser apparatus 1 and is stored in storing means such as the HDD 14 of the browser apparatus 1. Then, the result of the search is displayed as an arrangement of the links to sites and/or pages on an initial screen when the browser apparatus 1 is started up next. Thus, a user can access a site having valuable information that attracts the interests of the general public in the world from the initial screen of the browser apparatus 1, and it makes accesses to the information efficient.

Further, although sites are searched in this embodiment, pages, or both of pages and sites may be searched.

Another search method by the server apparatus 3 will now be described.

With this search method, when receiving a request for making a search from the browser apparatus 1 via the network interface 45, the CPU 41 of the server apparatus 3 starts up the search engine 52, and searches sites and/or pages on the network 2 in response to the request.

The CPU 41 of the server apparatus 3 refers to connected site data 53 of the HDD 44, reads out the accumulated number of accesses, to be described later, for each site found by the search engine 52, arranges all the found sites in accordance with the accumulated number of accesses so that the site having the larger accumulated number of accesses is ranked higher, and transmits information on the arrangement of the found sites as the result of the search to the browser apparatus 1 via the network 2.

When receiving the information on the arrangement of the sites, the browser apparatus 1, in accordance with the browser program, has the link to each site displayed on the display 16 in the order of the arrangement.

Here is described the accumulated number of accesses to each site. If the browser apparatus 1, that is the requester of the search, accesses any of the sites noticed as the result of the search, the CPU 41 of the server apparatus 3 accumulates the number of accesses to the site and records or updates the accumulated number of accesses in the connected site data 53 of the HDD 44.

That is, when the user clicks a link to any of the sites in the result of the search displayed by the browser apparatus 1 with the GUI (Graphical User Interface), the browser apparatus 1 notifies the server apparatus 3 that the site is selected, and then the server apparatus 3 increases the accumulated number of accesses to the site by one for updating it.

In this way, the server apparatus 3 aggregates the accumulated number of accesses for each site that is selected from the result of the search and accessed, arranges the sites found in the search in accordance with the accumulated number of accesses so that the site having the larger accumulated number of accesses is ranked higher, and notifies the browser apparatus 1 of the arrangement.

Thus, the result of a search can be obtained in which the sites and/or the pages are arranged in the order of the degree of reliability or completeness of information and the degree of the user's interest by making use of the fact that sites and/or pages with higher reliability or completeness of information are accessed more.

In addition, the result of the search in which the sites are arranged in accordance with the accumulated number of accesses so as to give the higher rank to the site having the larger accumulated number of accesses, is transmitted from the server apparatus 3 to the browser apparatus 1 and is stored in storing means such as the HDD 14 of the browser apparatus 1. Then, the result of the search is displayed as an arrangement of the links to sites and/or pages on the initial screen when the browser apparatus 1 is started up next. Thus, a user can access a site having information that the user is interested in and that is excellent in reliability or completeness from the initial screen of the browser apparatus 1, and the user can access preferred sites and/or pages efficiently. Further, although sites are searched in this embodiment, pages, or both of pages and sites may be searched.

Yet another search method in the search system shown in FIG. 1 will now be described. This search method records and aggregates the number of accesses utilizing the HDD 14 of the browser apparatus 1 rather than the HDD 44 of the server apparatus 3.

In this search method, the browser apparatus 1 records a history of a site as the history data 23 in the HDD 14 each time when the browser apparatus 1 accesses the site in accordance with the browser program 21.

When transmitting a request for making a search to the server apparatus 3 and receiving information of the sites found in the search as the result of the search from the server apparatus 3, the browser apparatus 1 refers to the history data 23 of the HDD 14, and aggregates the number of accesses with respect to each site received as the result of the search. Then, the browser apparatus 1 arranges the sites received as the result of the search in accordance with the number of accesses so that the more accessed site is ranked higher, and causes the display 16 to display the links to the sites received as the result of the search in such arrangement. Further, in this case, the result of the search need not to be specifically arranged in a specific order by the server apparatus 3. In addition, although the sites found in the search is arranged in accordance with the browser program 21 in the browser apparatus 1, the browser program 21 may be one for general purposes, and executed it with a plug-in program or the like.

In this way, the browser apparatus 1 arranges the sites found in the search in accordance with the number of accesses so that the more accessed site is ranked higher based on the history data 23, and causes the display 16 to display them.

Thus, the result of a search can be obtained in which the sites and/or the pages are arranged in the order of the degree of reliability or completeness of information and the degree of the user's interest by making use of the fact that sites and/or pages with higher reliability or completeness of information are accessed more.

In addition, the browser apparatus 1 displays the result of the search stored in the HDD 14 on the initial screen when the browser apparatus 1 is started up next. Thus, a user can access a site having valuable information that the user is interested in from the initial screen of the browser apparatus 1, and the user can access preferred sites and/or pages efficiently.

Further, although the number of the browser apparatus shown in FIG. 1 is one for the convenience of description in the search system in the above-mentioned embodiment, the number is not limited to one, and naturally a plurality of browser apparatuses 1 may be connected to the network 2.

According to the present invention, a browser apparatus and a computer-readable medium can be provided with which a user, even a computer illiterate, can easily browse various kinds of desired information on a network with simple operations. This is achieved by displaying the links to the sites and/or pages accessed in the past which are arranged in accordance with the number of accesses so that the link to a site or a page accessed more is ranked higher.

In addition, in accordance with the present invention, a browser apparatus, a server apparatus, a computer-readable medium, a search system and a search method can be provided which are capable of obtaining the result of a search in which sites and/or pages are arranged in the order of the degree of reliability or completeness of information.

Thus, it is seen that a browser apparatus, a server apparatus, a computer-readable medium, a search system and a search method are provided. One skilled in the art will appreciate that the present invention can be practiced by other than the preferred embodiments which are presented for the purposes of illustration and not of limitation, and the present invention is limited only by the claims which follow.

What is claimed is:

1. A browser apparatus for accessing a page laid open in a site on a network to display the contents of the page on a display device, comprising:
access recording means for recording a history of each site or page accessed;
access counting means for counting the number of accesses to each site or page accessed in the past based on the history recorded by said access recording means; and
arranging means for arranging the links to the accessed sites and/or pages in accordance with the counted number of accesses so that the link to the site or the page accessed more is ranked higher, and for causing said display device to display the arranged links on an initial screen.

2. A browser apparatus as claimed in claim 1, wherein said arranging means causes said display device to display the number of accesses to each site or page together with the link to the site or the page.

3. A browser apparatus as claimed in claim 1, further comprising storing means for storing information of one or more predetermined sites and/or pages in advance, wherein said arranging means causes said display device to display, on the initial screen, one or more links to said one or more predetermined sites and/or pages based on the information stored in said storing means as well.

4. A browser apparatus as claimed in claim 2, further comprising storing means for storing information of one or more predetermined sites and/or pages in advance, wherein said arranging means causes said display device to display, on the initial screen, one or more links to said one or more predetermined sites and/or pages based on the information stored in said storing means as well.

5. A browser apparatus for accessing a page laid open in a site on a network to display the contents of the page on a display device, comprising:
transmitting means for transmitting a request for making a search of sites and/or pages on the network to a predetermined server;
receiving means for receiving the result of the search corresponding to the request; and
arranging means for causing a display device to display, on an initial screen, the links to sites and/or pages found in the search, based on the result of the search received by said receiving means.

6. A computer-readable medium having recorded therein a program that causes a computer to function as a browser apparatus for accessing a page laid open in a site on a network to display the contents of the page on a display device, wherein said program causes said computer to function as:
access recording means for recording a history of each site or page accessed;
access counting means for counting the number of accesses to each site or page accessed in the past based on the history recorded by said access recording means; and
arranging means for arranging the links to the accessed sites and/or pages in accordance with the counted number of accesses so that the link to the site or the page accessed more is ranked higher, and for causing said display device to display the arranged links on an initial screen.

7. A computer-readable medium as claimed in claim 5, wherein, according to said recorded program, said arranging means causes said display device to display the number of accesses to each site or page together with the link to the site or the page.

8. A computer-readable medium as claimed in claim 6, wherein, according to said recorded program, said arranging means causes said display device to display, on the initial screen, one or more links to one or more predetermined sites and/or pages registered in advance as well.

9. A computer-readable medium as claimed in claim 7, wherein, according to said recorded program, said arranging means causes said display device to display, on the initial screen, one or more links to one or more predetermined sites and/or pages registered in advance as well.

10. A computer-readable medium having recorded therein a program that causes a computer to function as a browser apparatus for accessing a page laid open in a site on a network to display the contents of the page on a display device, wherein said program causes said computer to function as:
transmitting means for transmitting a request for making a search of sites and/or pages on the network to a predetermined server;
receiving means for receiving the result of the search corresponding to the request; and
arranging means for causing a display device to display, on an initial screen, the links to sites or pages found in the search based on the result of the search received by said receiving means.

11. A server apparatus for searching sites and/or pages on a network to output the result of a search, comprising:
searching means for searching sites and/or pages on the network;
access counter value obtaining means for obtaining the values of access counters in sites and/or pages found by said searching means; and
arranging means for arranging the sites and/or the pages found by said searching means in accordance with the access counter values obtained by said access counter value obtaining means so that the site or the page having the larger access counter value is ranked higher, and for outputting the information on the arrangement of the sites and/or pages as the result of the search.

12. A search method for searching sites and/or pages on a network to output the result of the search, comprising the steps of:
searching sites and/or pages on the network;
obtaining the values of access counters in sites and/or pages found in the search; and
arranging the sites and/or the pages found in the search in accordance with the obtained access counter values so that the site or the page having the larger access counter value is ranked higher, and for outputting the information on the arrangement of the sites and/or pages as the result of the search.

13. A computer-readable medium having recorded therein a program that causes a computer to function as a server apparatus for searching sites and/or pages on a network to output the result of the search, wherein said program causes said computer to function as:
searching means for searching sites and/or pages on the network;
access counter value obtaining means for obtaining the values of access counters in sites and/or pages found by said searching means; and
arranging means for arranging the sites and/or the pages found by said searching means in accordance with the access counter values obtained by said access counter value obtaining means so that the site or the page having the larger access counter value is ranked higher, and for outputting the information on the arrangement of the sites and/or pages as the result of the search.

14. A search system comprising a browser apparatus for requesting a search and a server apparatus, said server apparatus including:
searching means for searching sites and/or pages on a network in response to the request of the search;
access counter value obtaining means for obtaining the values of access counters in sites and/or pages found by said searching means; and
arranging means for arranging the sites and/or the pages found by said searching means in accordance with the access counter values obtained by said access counter value obtaining means so that the site or the page having the larger access counter value is ranked higher, and for transmitting the information on the arrangement of the sites and/or pages as the result of the search to said browser apparatus.

15. A search system as claimed in claim 14, wherein the links to the sites and/or the pages found in the search are displayed on an initial screen of a display device of said browser apparatus, based on the result of the search transmitted from said server apparatus.

16. A server apparatus for searching sites and/or pages on a network to output the result of a search, comprising:
receiving means for receiving a request for making a search;
searching means for searching sites and/or pages on the network in response to the request for making a search;
accumulated number recording means for accumulating and recording, if the requester of the search accesses a site or a page obtained as the result of the search by said searching means, the number of accesses to the site or the page; and
arranging means for arranging sites and/or pages found by said searching means in accordance with the number of accesses accumulated by said accumulated number recording means so that the site or the page having the larger accumulated number of accesses is ranked higher, and for outputting the information on the arrangement of the sites and/or pages as the result of the search.

17. A search method for searching sites and/or pages on a network, comprising the steps of:
receiving a request for making a search;
searching sites and/or pages on the network in response to the request;
accumulating, if the requester of the search accesses a site or a page obtained as the result of the search, the number of accesses to the site or the page; and
arranging sites and/or pages found in the search in accordance with the accumulated number of accesses so that the site or the page having the larger accumulated number of accesses is ranked higher, to thereby output the information on the arrangement of the sites and/or pages as the result of the search.

18. A computer-readable medium having recorded therein a program that causes a computer to function as a server apparatus for searching sites or pages on a network to output the result of the search, wherein said program causes said computer to function as:
receiving means for receiving a request for making a search;
searching means for searching sites and/or pages on the network in response to the request;
accumulated number recording means for accumulating and recording, if the requester of the search accesses a site or a page obtained as the result of the search by said searching means, the number of accesses to the site or the page; and
arranging means for arranging sites and/or pages found by said searching means in accordance with the accumulated numbers of accesses accumulated by said accumulated number recording means so that the site or the page having the larger accumulated number of accesses is ranked higher, and for outputting the information on the arrangement of the sites and/or pages as the result of the search.

19. A search system comprising a browser apparatus for requesting a search and for accessing a site or a page on a network and a server apparatus, said server apparatus including:
receiving means for receiving the request for making a search;
searching means for searching sites and/or pages on the network in response to the request;
accumulated number recording means for accumulating and recording, if said browser apparatus accesses a site or a page obtained as the result of the search by said searching means, the number of accesses to the site and/or the page; and
arranging means for arranging sites or pages found by said searching means in accordance with the accumulated number of accesses accumulated by said accumulated number recording means so that the site or the page having the larger accumulated number of accesses is ranked higher, and for outputting the information on the arrangement of the sites and/or pages as the result of the search.

20. A search system as claimed in claim 19, wherein the links to the sites and/or the pages found in the search are displayed on the initial screen of a display device of said browser apparatus, based on the result of the search transmitted from said server apparatus.

21. A browser apparatus for accessing a page laid open in a site on a network to display the contents of the page on a display device, comprising:
access recording means for recording a history of each site or page accessed;
transmitting means for transmitting a request for making a search to a predetermined server;
receiving means for receiving information on sites and/or pages from said server as the result of the search;
aggregating means for aggregating the number of accesses to each site or page received by said receiving means based on the history recorded by said access recording means; and
arranging means for arranging the links to the sites and/or pages received by said receiving means based on the history recorded by said access recording means, so that the link to the site or the page accessed more is ranked higher, and for causing said display device to display the arranged links.

22. A browser apparatus as claimed in claim 21, wherein the links to sites and/or pages arranged in the order of frequency of accesses to the sites and/or the pages are displayed on an initial screen of said display device of said browser apparatus.

23. A search method for searching sites and/or pages on a network, comprising the steps of:
recording a history of each site or page accessed;
transmitting a request for making a search to a predetermined server;
receiving information on sites and/or pages from said server as the result of the search;
aggregating the number of accesses to each site or page received from said server based on the recorded history; and
arranging the links to the sites and/or pages received by said receiving means based on the recorded history, so that the link to the site or the page accessed more is ranked higher, to thereby cause a display device of a browser apparatus to display the arranged links.

24. A search method as claimed in claim 23, wherein the links to sites and/or pages arranged in the order of frequency of accesses to sites and/or pages are displayed on an initial screen of said display device of said browser apparatus.

25. A computer-readable medium having recorded therein a program that causes a computer to function as a browser apparatus for accessing a page laid open in a site on a network to display the contents of the page on a display device, wherein said program causes said computer to function as:
access recording means for recording a history of each site or page accessed;
aggregating means for aggregating the number of accesses to each site or page received from a predetermined server based on the history recorded by said access recording means; and
arranging means for arranging the links to sites and/or pages received from said server based on the history recorded by said access recording means, so that the link to the site or the page accessed more is ranked higher, and for causing said display device to display the arranged links.

26. A computer-readable medium as claimed in claim 25, wherein, according to said program, the links to sites and/or pages arranged in the order of frequency of accesses to the sites and/or the pages are displayed on an initial screen of said display device of said browser apparatus.

27. A search system comprising:
a server apparatus for receiving a request for making a search, searching sites and/or pages on a network in response to the request for making a search, and outputting the result of the search; and
a browser apparatus, said browser apparatus including:
access recording means for recording a history of each site or page accessed;
transmitting means for transmitting a request for making a search to said server apparatus;
receiving means for receiving information of sites and/or pages as the result of the search from said server apparatus;
aggregating means for aggregating the number of accesses to each site or page received by said receiving means based on the history recorded by said access recording means; and
arranging means for arranging the links to the sites and/or the pages received by said receiving means based on the history recorded by said access recording means, so that the link to the site or the page accessed more is ranked higher, and for causing a display device to display the arranged links.

28. A search system as claimed in claim 27, wherein the links to sites and/or pages arranged in the order of frequency of accesses to the sites and/or the pages are displayed on an initial screen of said display device of said browser apparatus.
